(19) United States
(12) Patent Application Publication
(10) Pub. No.: US 2005/0078657 A1
(43) Pub. Date: Apr. 14, 2005

(54) Technique for dynamically routing communication calls to information/call centers

(76) Inventor: Christopher A. Huey, Banks, OR (US)

Correspondence Address: ALEX L. YIP;KAYE SCHOLER LLP, 425 PARK AVENUE, NEW YORK, NY, 10022, US

(21) Appl. No.: 10/676,473

(22) Filed: Sep. 30, 2003

(51) Int. Cl. H04L 12/56

(52) U.S. Cl. 370/352; 370/395.5

(57) ABSTRACT

In providing an information assistance service, information assistance calls are routed through a telephone carrier switch to information/call centers for handling the calls. For each call, the carrier switch establishes a Voice over Internal protocol (VoIP) call session, and conducts handshaking with a redirect server in an information assistance system, e.g., in accordance with a session initiation protocol (SIP). In response to an Invite message to the redirect server, the redirect server provides a list of available call centers in a Multiple Choices response message to the carrier switch. The latter negotiates with ones of the call centers on the list to set up the VoIP call session.

### FIELD OF THE INVENTION

The invention relates to a communications system and method, and more particularly to an information assistance system and method for distributing communication calls among information/call centers.

### BACKGROUND OF THE INVENTION

It is common that an information assistance service provider sets up information/call centers (conveniently referred to hereinafter as “call centers”) in different geographic areas to handle information assistance calls from users. One such information assistance call typically is routed by a telephone carrier to a call center based on call origination, e.g., all calls from Minneapolis are routed to a nearby Chicago call center in the first instance. The information assistance service provider oftentimes needs to meet certain quality of service (QOS) requirements, e.g., the maximum wait time before a call is answered, to gain customer satisfaction. For example, to meet the maximum wait time requirement, if a call center, for whatever reasons, is unable to answer a call within a predetermined period, the call is rerouted to another call center in accordance with a call routing algorithm.

To take advantage of the virtually free transport of the Internet, an increasing number of voice calls, including information assistance calls, are realized based on a Voice over Internet Protocol (VoIP). Specifically, the voice content of a call is digitized and reformatted into VoIP packets, which are then routed through the Internet to a destination server. Such packets are reassembled at the destination server and the voice content is reconstructed, which process is transparent to both the caller and the called party. A session initiation protocol (SIP) is particularly useful for establishing and terminating a VoIP call session. For details on the SIP, one may refer, e.g., to: “SIP: Protocol Overview,” http://www.radvision.com, Radvison Ltd., 2001.

### SUMMARY OF THE INVENTION

The invention is directed to dynamically routing calls, e.g., VoIP calls, to information assistance providers, e.g., call centers, operators, etc. for handling the calls. In accordance with the invention, before a call session is established, a device for routing the call, e.g., a telephone carrier switch, identifies the call center to which the call is routed. To that end, the carrier switch sends to a server, e.g., redirect server, in an information assistance system a first message, e.g., a SIP Invite message, which requests acceptance of the call thereby. In response, a list of selected information assistance providers available to accept the call is compiled, based on measures of current conditions of the plurality of information assistance providers. The server responds to the SIP Invite message with a second message, e.g., a SIP Multiple Choices message, which includes a subset of the selected information assistance providers. In response to such a second message, the carrier switch sends the SIP Invite message to at least one of the selected information assistance providers in the subset, again requesting acceptance of the call thereby.

In an illustrative embodiment, the carrier switch sends the SIP Invite message to the information assistance providers in the subset sequentially. Only after one of the information assistance providers responds with a SIP OK message, does the carrier switch forward the call to the information assistance provider. If none of the information assistance providers are available, the caller is so informed and may be asked to try again later.

In another illustrative embodiment, based on a recognition of the dynamic nature of the availability of information assistance providers, after exhausting an initial list of information assistance providers, the carrier switch may be “tricked” into sending a second SIP Invite message to the redirect server. This may be achieved by including the redirect server's IP address as an entry in the initial list of information assistance providers. In response to this second Invite message, the redirect server fetches a new list of available information assistance providers with which the carrier switch attempts to establish the call session.

In yet another illustrative embodiment, a condition may be set in the initial list of information assistance providers, which requires the carrier switch to send a second Invite message to the redirect server when the condition is met, thereby obtaining a new list of available information assistance providers.

Advantageously, with the invention, an information assistance call is only routed to an information assistance provider after the provider confirms its availability to answer the call. The limited network bandwidth is effectively utilized as only relatively short messages are exchanged before a call is connected to an information assistance provider, as opposed to dedicating a channel to communicating the call even before availability of a provider is determined as in prior art.

### BRIEF DESCRIPTION OF THE DRAWINGS

Further objects, features and advantages of the invention will become apparent from the following detailed description taken in conjunction with the accompanying drawings showing an illustrative embodiment of the invention, in which:

FIG. 1 illustrates a communications arrangement where information assistance calls are routed to an information assistance system, in accordance with the invention;

FIG. 2 is a flow chart depicting a process for compiling a list of call centers available to answer an information assistance call;

FIG. 3 illustrates a list of call centers available to answer an information assistance call;

FIG. 4 is a flow chart depicting a process for searching for a call center on the list to answer an information assistance call;

FIG. 5 illustrates a list of call centers available to answer an information assistance call, including those call centers which are equally ranked;

FIG. 6 illustrates a list of call centers available to answer an information assistance call, with the IP address of a redirect server inserted therein; and

FIG. 7 illustrates a list of call centers available to answer an information assistance call, with a condition inserted therein.

### DETAILED DESCRIPTION

The invention is directed to dynamically routing information assistance calls, e.g., VoIP calls, to call centers to effectively provide an information assistance service. In accordance with the invention, an information assistance call is routed according to instructions by a redirect server in an information assistance system. To that end, for example, before a telephone carrier switch forwards an information assistance call to a call center, it conducts handshaking with the redirect server in accordance with the well known session initiation protocol (SIP), including sending a message inviting the redirect server to accept the call, with no knowledge that the redirect server in the present invention does not accept any call. Rather, the redirect server replies with a SIP Multiple Choices message (also known as a “SIP 300 message”) containing a list of call centers which may be able to accept the call, in accordance with the invention. Based on the received list, the carrier switch then sends a similar invite message to request the call centers on the list to accept the call. The list of call centers provided by the redirect server may be compiled by a call routing server based on the current load or other conditions of various call centers, in accordance with a dynamic call routing algorithm. One such dynamic call routing algorithm is described, e.g., in copending, commonly assigned U.S. application Ser. No. 09/861,777, filed on May 21, 2001, which is incorporated herein by reference.

In an illustrative embodiment, the telephone carrier switch sends a SIP Invite message to the call centers on the received list sequentially. Only after one of the call centers responds with a SIP OK message, does the carrier switch forward the information assistance call to the call center. In other words, if a call center responds with a SIP Unavailable message indicating unavailability of the call center, the carrier switch queries the next call center on the list, and so on and so forth until one of them confirms its availability to answer the call. Otherwise, if none of the call centers on the list are available, the caller is so informed and may be asked to try again later. However, in another illustrative embodiment, based on a recognition of the dynamic nature of the availability of call centers, after exhausting at least part of an initial list of call centers, the carrier switch may be “tricked” into sending a second SIP Invite message to the redirect server. This may be achieved by including the redirect server's IP address as an entry in the initial list of call centers. In response to this second Invite message, the redirect server fetches a new list of available call centers with which the carrier switch attempts to establish an information assistance call session. In yet another illustrative embodiment, a condition may be set in the initial list of call centers, which requires the carrier switch to send a second Invite message to the redirect server when the condition is met, thereby obtaining a new list of available call centers.

Advantageously, with the invention, an information assistance call is only routed to a call center after the call center confirms its availability to answer the call. The limited network bandwidth is effectively utilized as only relatively short messages are exchanged before a call is connected to a call center, as opposed to dedicating a channel to communicating the call even before availability of a call center is determined as in prior art.

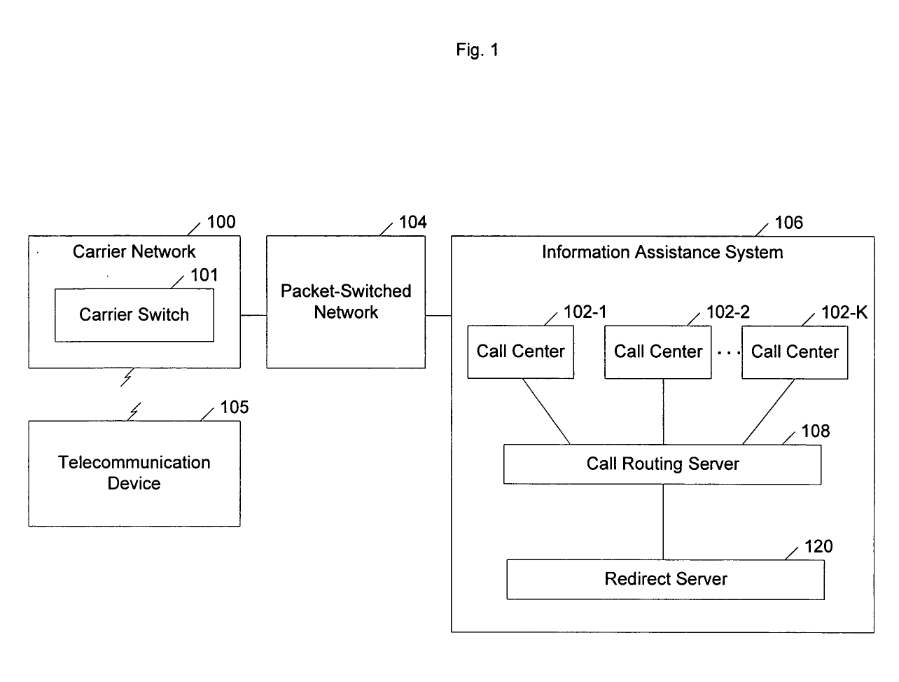

FIG. 1 illustrates a communications arrangement embodying the principles of the invention where call centers 102-1, 102-2, . . . 102-K in the information assistance system 106 handle information assistance calls, where K represents a predetermined number greater than one. Users of a particular telephone carrier, e.g., AT&T, Verizon or Sprint, may dial, speak or otherwise communicate predetermined access digits, access codes or retail numbers, or input a predetermined address or URL (uniform resource locator) on their telecommunications device 105 (e.g., wireline telephone, wireless telephone, PDA, etc.) to seek information assistance. For example, the predetermined access digits may be “411,” “*555,” “555-1212,” “00,” etc. Information assistance may be provided by operators in call centers 102-1 through 102-K, which includes, e.g., providing the desired phone numbers and addresses of particular persons and businesses, directions, movie listings, restaurant recommendations, etc. It should be pointed out that the term “operator” here broadly encompasses entities that are capable of providing assistance in a telecommunication environment, including without limitation human operators, voice response/recognition capabilities, web-enabled operator services, and other electronic access.

An information assistance call, e.g., initiated from telecommunication device 105, is routed in a conventional manner through carrier network 100, e.g., a public switched telephone network (PSTN), to a carrier switch therein, denoted 101. In this instance, to effectively utilize the limited bandwidth of the carrier network 100, switch 101 is programmed to packetize the voice content of the call, in accordance with the VoIP, and the resulting packets are transmitted through packet-switched network 104, e.g., the Internet. In a well known manner, the transmitted packets are reassembled at a destination switch to recover the voice content. The voice content is then conveyed to an operator at a call center, thereby realizing the information assistance call. However, before the VoIP call session is established, switch 101 in this instance needs to identify the call center to which the call is connected. To that end, a call routing algorithm is implemented in call routing server 108. Each of call centers 102-1 through 102-K is connected to call routing server 108, e.g., via a wide area network. Server 108 receives from the call centers measures of their conditions, necessary for the call routing algorithm to identify available call centers. Examples of such measures or metrics concerning the call centers, e.g., call center 102-1, are enumerated as follows:

(1) Call Abandonment (CA) metric—this metric indicates the percentage of callers that have hung up after experiencing a set answer delay, e.g., 24 seconds in this instance. A relatively high CA metric value indicates that a relatively high percentage of calls received by call center 102-1 were abandoned by the callers because of a long answer delay. Thus, one may want to set a maximum limit on the CA metric value, say, 20%, to meet a certain QOS requirement. When the CA metric value of call center 102-1 exceeds the maximum limit, call center 102-1 is likely not to be able to answer a current call within the maximum wait time.

(2) Calls in Queue (CIQ) metric—this metric measures the number of incoming calls waiting in the queue to be answered by call center 102-1. The higher the CIQ metric value, the higher the likelihood that a current call, if it were connected to call center 102-1, would become an overflow call and would have to be rerouted to a different call center. The CIQ metric value may be weighted against the number of logged in or active operators in call center 102-1, indicated by metric value (5) below. This stems from the fact that the more (fewer) active operators in the call center, the more (fewer) calls in the queue they can answer within the maximum wait time. Thus, the CIQ metric value relative to the number of active operators may be more effective in determining a call center where a current call should be routed.

(3) Direct Call Processing Time (DCPT) metric—this metric indicates the average duration of a call after the call is picked up by an operator in call center 102-1, thereby measuring the efficiency of the operators answering the incoming calls. The higher the DCPT metric value, the more likely that a current call would not be answered within the maximum wait time. For example, a high DCPT value may be a minute or more.

(4) H metric—this metric measures the number of calls processed per hour by the operators in call center 102-1. The higher the H metric value, i.e., the larger the number of calls answered by the operators per hour, the less likely that a current call would not be answered within the maximum wait time. Like the CIQ metric, the H metric may be weighed against the number of active operators, indicated by metric value (5) below, as what constitutes a high H metric value depends on the number of active operators in call center 102-1.

(5) Logged in Operators (LIO) metric—this metric measures the number of operators who have logged in the system to answer calls in call center 102-1. As mentioned before, this metric may be considered in combination with other metrics such as the CIQ and H metrics.

(6) Longest Queue Time (LQT) metric—this metric measures the longest queue time for any incoming call waiting in the queue to be answered. Additional incoming calls would likely be designated overflow calls and would have to be rerouted to a different call center if the LQT metric value exceeds a predetermined threshold.

(7) Rerouted Inbound Calls in Progress (RICIP) metric—this metric measures the number of calls being rerouted to call center 102-1 from other call centers 102-2, . . . 102-K (“overflow calls”). A high RICIP metric value indicates a high rate of acceptance of overflow calls in call center 102-1, and the call center is likely to not designate any incoming call an overflow call since the call volume is manageable.

(8) Rerouted Outbound Calls in Progress (RICIP) metric—this metric measures the number of overflow calls being rerouted from call center 102-1 to an alternate call center. If call center 102-1 is already rerouting many of its incoming calls, it is likely that call center 102-1 would need to continue to designate an incoming call an overflow call and reroute same.

(9) Time Service Factor (TSF) metric—this metric measures the percentage of calls answered in call center 102-1 within a predetermined time limit, e.g., 24 seconds, to meet a QOS requirement. The higher the TSF metric value, the more likely that a current call would not be designated an overflow call and would not have to be rerouted to an alternate call center.

Based upon an analysis and weighing of such metrics concerning each of call centers 102-1, 102-2, . . . 102-K, call routing server 108 selects one or more call centers which are most likely available to answer the current call.

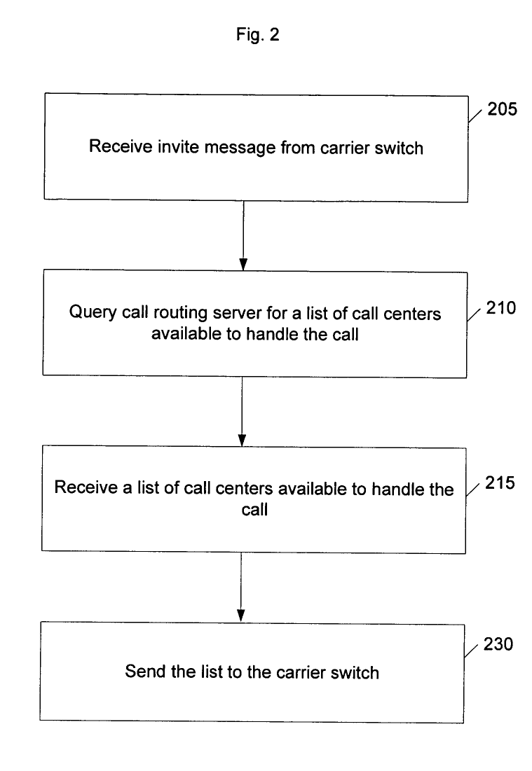

Call routing server 108 communicates to redirect server 120 the list of most likely available call centers for handling the current information assistance call. Redirect server 120 also communicates with switch 101 in accordance with the SIP to establish a VoIP call session. Carrier switch 101 initiates the call session by sending a SIP Invite message destined to the IP address of server 120. Treating server 120 as an intended recipient of the call (i.e., a call center), carrier switch 101 expects a response from server 120 whether it can accept the call. However, redirect server 120 in accordance with the invention does not reply with a simple “OK” or “Unavailable” message. Rather, after redirect server 120 receives the SIP Invite message from carrier switch 101, as indicated in step 205 in FIG. 2, server 120 requests a list of call centers available to answer the current information assistance call. Thus, in step 210, redirect server 120 queries call routing server 108 for such a list of call centers. In response, call routing server 108 analyzes and weighs the aforementioned measures of conditions of the call centers in accordance with a call routing algorithm, and identifies one or more call centers which are most likely available to answer the current call. In step 215, redirect server 120 receives the list of available call centers, represented by their IP addresses, from call routing server 108. In step 230, redirect server 120 sends to switch 101 a SIP Multiple Choices message, including the list of IP addresses of available call centers.

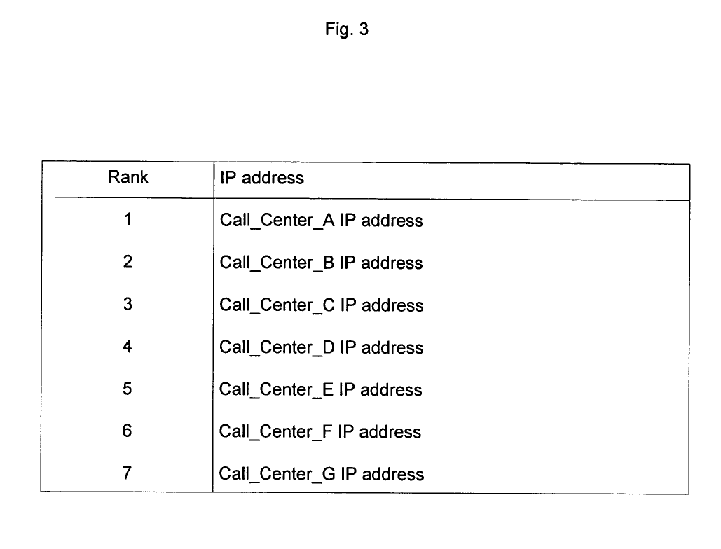

FIG. 3 illustrates one such list of IP addresses of available call centers. In this instance, the call centers are ranked, with the most likely available call center ranked first. The ranking of a call center is indicated by a “q-value” associated with the call center in the SIP Multiple Choices message. The higher the q-value is, the more likely the associated call center available. As shown in FIG. 3, Call_Center_A is ranked first indicating that it currently is most likely available to answer an information assistance call, followed by Call_Center_B, . . . , and Call_Center G, in that order.

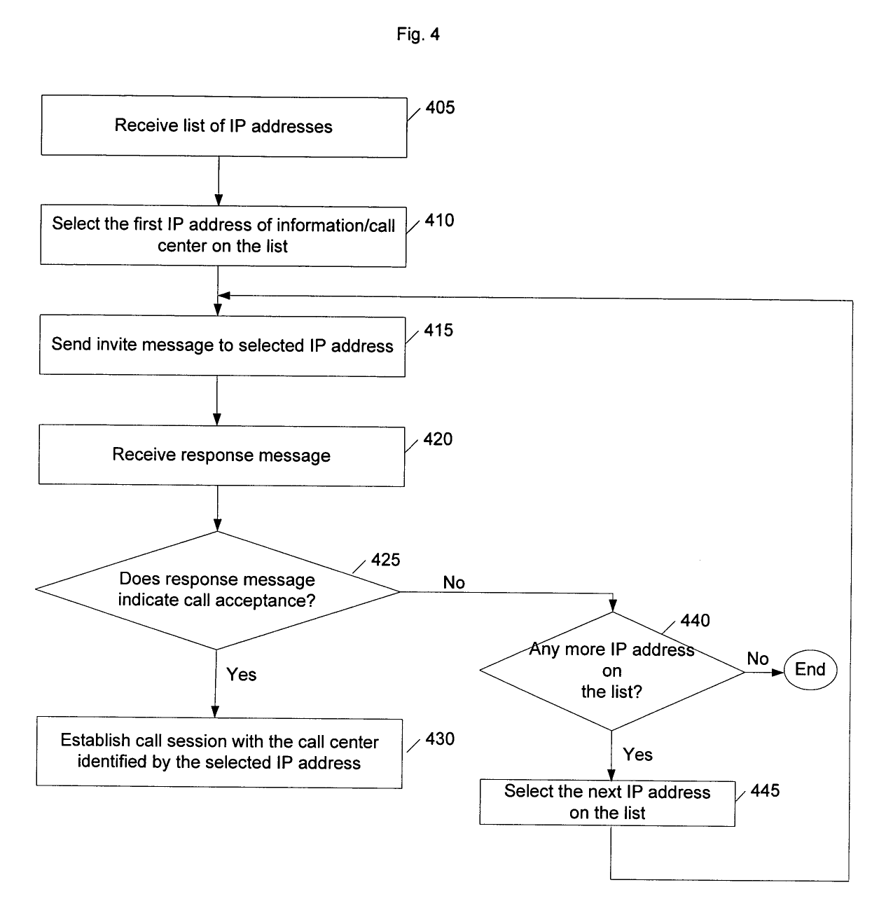

FIG. 4 illustrates a routine performed by carrier switch 101, beginning with step 405 where carrier switch 101 receives from redirect server 120 the Multiple Choices message, which includes the list of IP addresses of available call centers of FIG. 3. In step 410, carrier switch 101 selects the IP address of a call center on the list, and initially selects that of Call_Center_A which is ranked first. In step 415, carrier switch 101 sends a SIP Invite message to the selected IP address. In step 420, carrier switch 101 receives a SIP Response message from the call center identified by the selected IP address. In step 425, carrier switch 101 determines whether the response message is a SIP OK message indicating a call acceptance. If so, carrier switch 101 sends a SIP ACK message to the selected IP address to establish a call session with the call center identified thereby, as indicated in step 430. As a result, the caller hears his/her call being answered, and may start a phone conversation. The voice content of the conversation is packetized by switch 101 in accordance with the VoIP. The resulting packets are transmitted through network 104 to the call center to realize the information assistance call in a conventional manner.

Otherwise, if it is determined that the response message indicating unavailability of the call center, e.g., a SIP Unavailable message, carrier switch 101 in step 440 determines whether there is an additional IP address(es) on the list to which carrier switch 101 has not sent an Invite message. If not, the subject routine comes to an end, where a recorded message may be played to the user, e.g., “No information assistance service is available,” “All circuits are busy,” “Please call again later,” etc., and the call is then disconnected. Otherwise, carrier switch 101 in step 445 selects the next IP address on the list, and the routine returns to step 415 described before.

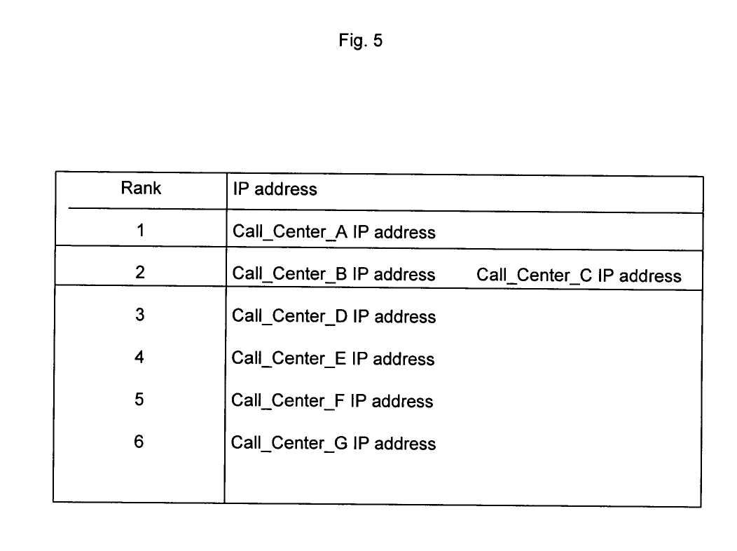

In a second embodiment, to take advantage of a well known SIP “parallel search” feature afforded to switch 101, the aforementioned list of available call centers sent by redirect server 120 may contain two or more call centers which are equally ranked, i.e., equally likely to answer the current information assistance call. One such list is illustrated in FIG. 5, where both Call_Center_B and Call_Center_C in this instance are ranked second, after Call_Center_A. Thus, in this example, when carrier switch 101 has unsuccessfully tried to connect the current information assistance call to Call_Center_A, carrier switch 101 uses the SIP parallel search feature to multicast a SIP Invite message to both Call_Center_B and Call_Center_C simultaneously because of their equal ranking. In return, carrier switch 101 receives two SIP response messages from Call_Center_B and Call_Center_C, respectively. If both Call_Center_B and Call_Center_C respond with a SIP OK message, carrier switch 101 selects, with or without preference, either Call_Center_B or Call_Center_C with which a call session is to be established. If only one of Call_Center_B and Call_Center_C responds with a SIP OK message, carrier switch 101 establishes a call session with the call center that responded favorably. If none of Call_Center_B and Call_Center_C responds with a SIP OK message, carrier switch 101 selects the IP address of Call_Center_D (ranked next to Call_Center_B and Call_Center_C on the list) to which an Invite message is to be sent, in accordance with step 415 in FIG. 4. Steps 420, 425, 430, 440 and 445 then follow as shown in FIG. 4.

In a third embodiment, redirect server 120 may revise the list of available call centers provided by call routing server 108 and include the revised list in the Multiple Choices response message to carrier switch 101. For example, redirect server 120 may truncate the list from server 108 (e.g., FIG. 3) to keep only a predetermined number of top ranked call centers (e.g., only Call_Center_A through _C) to impose an upper limit on the number of attempts (e.g., 3) to search for a call center to connect the call.

In addition, the imposition of such an upper limit is sensible in that it not only limits the wait time before a caller knows whether the information assistance call can be connected, but may also serve as a condition for obtaining a new list of available call centers from call routing server 108, in accordance with an aspect of the invention. Such a new list is warranted because if the predetermined number of top ranked call centers on the current list which were most likely available to answer the call a short while ago have become unavailable now, the load or other conditions of call centers 102-1 through 102-K may have drastically changed. Such a drastic change may be due to a sudden power outage at a call center, or an abnormal increase in call volume in a geographic region, e.g., caused by a sudden disaster in that region.

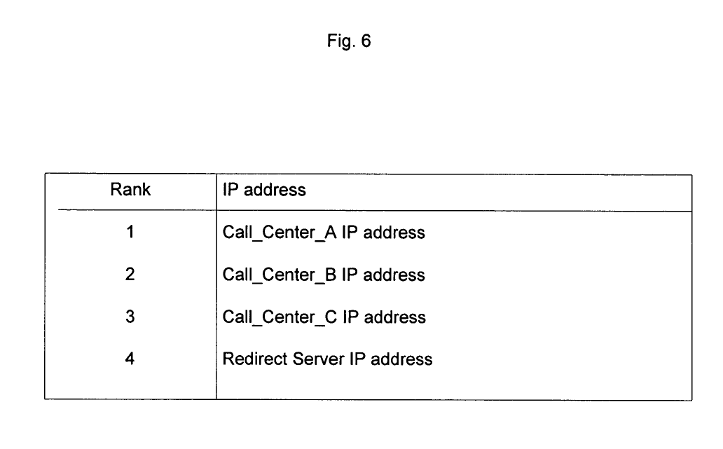

In implementation, to ensure that a request for a new list of available call centers is made after attempts to connect the call to the predetermined number of top ranked call centers have failed, redirect server 120 inserts its own IP address immediately after the IP addresses of such top ranked call centers on the list. FIG. 6 illustrates the resulting list, which is a revised version of the list of FIG. 3 received from server 108. Specifically, after redirect server 120 receives the list of FIG. 3 from call routing server 108, server 120 in this instance inserts its IP address immediately after the IP addresses of the top three ranked call centers on the list, e.g., Call_Center_A through _C. As a result, the list of FIG. 3 in effect is truncated, with the last entry being the IP address of redirect server 120. Thus, in accordance with the revised list of FIG. 6, after carrier switch 101 receives unfavorable responses to its Invite message from Call_Center_A through C, it sends an Invite message to redirect server 120 at its IP address. Server 120 then executes the routine of FIG. 2 described before, and sends a new list of available call centers to carrier switch 101, which may or may not be revised by server 120.

It should be noted that the number of lists in which redirect server 120 can insert its IP address to request a new list should be limited. Otherwise, the wait time for connecting the call may become indefinitely long, which is undesirable. In this example, because of a maximum wait time requirement, at most one new list can be requested. That is, redirect server 120 can only insert its IP address in the very first list received from server 108 for the current information assistance call. To that end, server 120 checks the header of an Invite message which in this instance includes an identifier associated with the current information assistance call, e.g., an automatic number identification (ANI). As is well known, the ANI represents the telephone number from which the call originates, which is provided to switch 101 in establishing the call. In this instance, if server 120 encounters a new ANI in the header of an Invite message, server 120 registers the new ANI and the time of receipt of the Invite message in a registry, and inserts its IP address in the list of available call centers from server 108, resulting in the revised list of FIG. 6 described before. When server 120 receives another Invite message containing the same ANI in its header, say, within the maximum wait time allowed for each information assistance call, server 120 checks the newly received ANI against the registered ANIs in the registry, and in this instance finds the corresponding ANI therein. As a result, server 120 determines that the Invite message just received is a repeat message thereto. As a result, it refrains from inserting its IP address in the new list of available call centers from server 108, and erases the ANI in question from the registry.

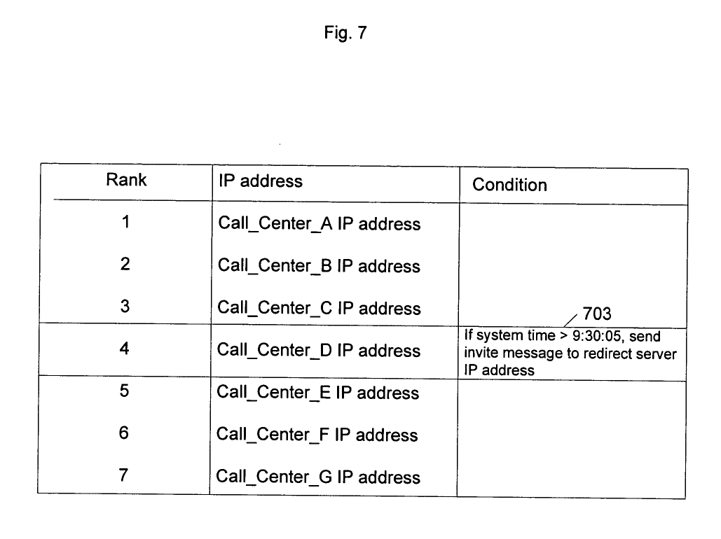

In a fourth embodiment, redirect server 120 may be programmed to set a condition for obtaining a new list of available call centers from server 108. That is, instead of inserting its IP address in a list of available call centers as demonstrated in FIG. 6, redirect server 120 here may insert in the list a time condition as to when a new list of available call centers is warranted. FIG. 7 illustrates a revised list by redirect server 120 in this embodiment, which is a revised version of the list of FIG. 3 initially received from server 108. As shown in FIG. 7, a time condition, denoted 703, has been established by redirect server 120 in the list, which specifies that carrier switch 101 can only send an Invite message to a particular call center (e.g., Call_Center_D) in the list before a selected time (e.g., 9:30:05 a.m.). Otherwise, at or after such selected time, carrier switch 101 sends the Invite message to redirect server 120, which then provides a new list of available call centers in the Multiple Choices response message to switch 101.

Time condition 703 is established by redirect server 120 to ensure that not too much time has been elapsed before it is determined that the current list has become “stale,” and there is sufficient time for obtaining a new list upon which switch 101 can act. The actual time limit is selected based on the system time at which redirect server 120 receives an Invite message from switch 101. In this instance, when redirect server 120 receives one such Invite message, it registers the time of its receipt, say, 9:30:00 a.m. In response to the Invite message, server 120 elicits from call routing server 108 a list of available call centers. Server 120 then refers to the list and the Invite message receipt time, and determines the appropriate time limit, 9:30:05 a.m., by which switch 101 should have sent an Invite message to Call_Center_D to meet a maximum wait time (e.g., 10 seconds) requirement. After formulating time condition 703, server 120 inserts the condition in the list alongside the IP address of Call_Center_D, as shown in FIG. 7.

Continuing with the above example, after receiving the revised list of FIG. 7, carrier switch 101 performs similar steps to those in FIG. 4 to attempt to establish a call session with one of the call centers in the revised list. Let's say all of the attempts by carrier switch 101 with respect to Call_Center_A through _C in this instance are unsuccessful (i.e., its invite messages met by Unavailability response messages from all three call centers). Based on the revised list of FIG. 7, carrier switch 101 realizes that sending an Invite message to the next Call_Center_D is conditional. As a result, it checks condition 703 before it sends an Invite message to Call_Center_D. If condition 703 is met (i.e., the current system time later than or equal to 9:30:05 a.m.), carrier switch 101 sends the invite message to the IP address of redirect sever 120, instead, which then provides a new list of available call centers in the Multiple Choices response message to switch 101. The new list may or may not have been revised by server 120. Otherwise, if condition 703 is not met, carrier switch 101 sends the Invite message to the IP address of Call_Center_D, in accordance with step 415 in FIG. 4. Steps 420, 425, 430, 440 and 445 then follow as shown in FIG. 4. It should be noted that server 120 here may also rely on the ANI associated with the call to track the number of Invite messages it has received for the same call, in a manner similar to that described in the previous embodiment, thereby limiting the number of requests for a new list of available call centers.

The foregoing merely illustrates the principles of the invention. It will thus be appreciated that those skilled in the art will be able to devise numerous other arrangements which embody the principles of the invention and are thus within its spirit and scope.

For example, it will be appreciated by those skills in the art that protocols other than the VoIP and SIP may be used to implement the present invention.

Finally, information assistance system 106 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

1. A method for routing a call to an information assistance system which includes a server and a plurality of information assistance providers, the method comprising:
receiving by the server a first request for acceptance of the call;
in response to the first request, compiling a list of selected information assistance providers available to accept the call, the list being compiled based on measures of current conditions of the plurality of information assistance providers; and
responding by the server to the request with a message, the message including a subset of the selected information assistance providers, thereby causing a second request for acceptance of the call to be sent to at least one of the selected information assistance providers in the subset.

2. The method of claim 1 wherein voice content of the call is formatted in accordance with a voice over Internet protocol (VoIP).

3. The method of claim 2 wherein the selected information assistance providers on the list are represented by IP addresses assigned thereto.

4. The method of claim 2 wherein at least one of the first request, second request and message is formatted in accordance with a session initiation protocol (SIP).

5. The method of claim 1 wherein the plurality of information assistance providers include at least one operator.

6. The method of claim 1 wherein the selected information assistance providers on the list are ranked according to their respective likelihoods of availability to accept the call.

7. The method of claim 6 wherein at least first and second ones of the information assistance providers in the subset are ranked equally, the second request for acceptance of the call being multicast to the first and second information assistance providers.

8. The method of claim 1 wherein the subset of the selected information assistance providers comprises each one of the selected information assistance providers on the list.

9. The method of claim 1 wherein one of the measures is a function of the number of callers hanging up communication calls in the system after a predetermined answer delay.

10. The method of claim 1 wherein one of the measures is a function of the number of communication calls being queued to be answered in the system.

11. The method of claim 1 wherein one of the measures is a function of a duration of a communication call answered in the system.

12. The method of claim 1 wherein one of the measures is a function of the number of communication calls answered in the system in a given period.

13. The method of claim 1 wherein one of the measures is a function of at least one of the number of information assistance providers and the number of operators attending to the communication calls in the system.

14. The method of claim 1 wherein one of the measures is a function of wait time before a communication call is answered in the system.

15. The method of claim 1 wherein one of the measures is a function of the number of communication calls rerouted to one of the information assistance providers from another information assistance provider.

16. The method of claim 1 wherein one of the measures is a function of the number of communication calls, each of which is answered in the system within a predetermined time limit.

17. The method of claim 1 wherein the communication call includes a telephone call.

18. The method of claim 1 wherein one of the measures is weighted relative to another measure.

19. A method for distributing communication calls among a plurality of receivers handling the calls, the method comprising:
receiving from a device a first request for handling of a communication call;
in response to the first request, a server obtaining a list of receivers available to handle the communication call;
revising the list to at least include selected data therein; and
sending to the device a message responsive to the first request, the message including the revised list, the device sending a second request for handling of the communication call to the server based on the selected data in the revised list, thereby causing the server to obtain a second list of receivers available to handle the communication call.

20. The method of claim 19 wherein the selected data includes information concerning the server.

21. The method of claim 20 wherein the information includes an address of the server to which the second request is sent.

22. The method of claim 19 wherein the selected data includes a condition under which the second request is sent to the server.

23. The method of claim 22 wherein the condition relates to time.

24. The method of claim 19 wherein the communication call seeks information assistance, and the plurality of receivers include information assistance providers.

25. The method of claim 19 wherein voice content of the communication call is formatted in accordance with a VoIP.

26. The method of claim 25 wherein the receivers on the list are represented by IP addresses assigned thereto.

27. The method of claim 25 wherein at least one of the first request, second request and message is formatted in accordance with a SIP.

28. The method of claim 19 wherein the receivers on the list are ranked according to their respective likelihoods of availability to handle the communication call.

29. A system for processing an information assistance call, comprising:
a plurality of information assistance providers;
a server for receiving a first request for acceptance of the call; and
a processor for compiling a list of selected information assistance providers available to accept the call, the list being compiled based on measures of current conditions of the plurality of information assistance providers, the server responding to the first request with a message, the message including a subset of the selected information assistance providers, thereby causing the a second request for acceptance of the call to be sent to at least one of the selected information assistance providers in the subset.

30. The system of claim 29 wherein voice content of the call is formatted in accordance with a VoIP.

31. The system of claim 30 wherein the selected information assistance providers on the list are represented by IP addresses assigned thereto.

32. The system of claim 30 wherein at least one of the first request, second request, and message is formatted in accordance with a SIP.

33. The system of claim 29 wherein the plurality of information assistance providers include at least on operator.

34. The system of claim 29 wherein the selected information assistance providers on the list are ranked according to their respective likelihoods of availability to accept the call.

35. The system of claim 34 wherein at least first and second ones of the information assistance providers in the subset are ranked equally, the second request being multicast to the first and second information assistance providers.

36. The system of claim 29 wherein the subset of the selected information assistance providers comprises each one of the selected information assistance providers on the list.

37. A system for distributing communication calls among a plurality of receivers handling the calls, the system comprising:
an interface for receiving, from a device, a first request for handling of a communication call; and
a server, responsive to the first request, for obtaining a list of receivers available to handle the communication call, the list being revised to at least include selected data therein, the server sending to the device a message responsive to the first request, the message including the revised list, the device sending a second request for handling of the communication call to the server based on the selected data in the revised list, thereby causing the server to obtain a second list of receivers available to handle the communication call.

38. The system of claim 37 wherein the selected data includes information concerning the server.

39. The system of claim 38 wherein the information includes an address of the server to which the second request is sent.

40. The system of claim 37 wherein the selected data includes a condition under which the second request is sent to the server.

41. The system of claim 40 wherein the condition relates to time.

42. The system of claim 37 wherein the communication call seeks information assistance, and the plurality of receivers include information assistance providers.

43. The system of claim 37 wherein voice content of the communication call is formatted in accordance with a VoIP.

44. The system of claim 43 wherein the receivers on the list are represented by IP addresses assigned thereto.

45. The system of claim 43 wherein the first request, the second request and the message are formatted in accordance with a SIP.

46. The system of claim 37 wherein the receivers on the list are ranked according to their respective likelihoods of availability to handle the communication call.

47. The system of claim 37 wherein the device includes a switching device.
